(19) United States
(12) Patent Application Publication
(10) Pub. No.: US 2002/0002685 A1
(43) Pub. Date: Jan. 3, 2002

(54) Secure computer

(76) Inventor: Youngtack Shim, Saratoga, CA (US)

Correspondence Address: YOUNGTACK SHIM, PENNIE & EDMONDS, LLP, 3300 HILLVIEW AVENUE, PALO ALTO, CA, 94304, US

(21) Appl. No.: 09/758,489

(22) Filed: Jan. 10, 2001

Related U.S. Application Data
(60) Provisional application No. 60/175,269, filed on Jan. 10, 2000.

(51) Int. Cl. G06F 12/14

(52) U.S. Cl. 713/200; 711/163

(57) ABSTRACT

The present invention generally relates to a secure computer which can protect information processed thereby from being accessed by an unauthorized intruder. The secure computer typically includes an access control system and a guard system. The access control system detects an unauthorized attempt to access the information and generates a protection command signal responsive to such attempts. Responsive to the protection command signal, the guard system degrades at least a portion of information stored in the computer by chemically, mechanically, and/or magnetically degrading the information processing system of the computer.

This application claims the benefit of an earlier filing date of U.S. Provisional Application bearing Ser. No. 60/175,269, entitled “Secure Computer” which was filed on Jan. 10, 2000.

### BACKGROUND OF THE INVENTION

With the advent of the computer technology, a smaller computer can store bulkier information in its information storage system such as its hard disks. The technological innovation in computer hardware fabrication technology has significantly reduced the cost of the computer as well. For example, information processing and storage systems with improved speed and capacity have been introduced to the market at a rapid pace with a lower price tag.

Even only a decade ago, the major value of a computer system lay in its hardware. Thus, when an user lost his or her computer to an intruder, the major loss used to be the capital required for replacing the hardware. Once new equivalent equipment had been acquired, the user had to load handful of disks of operating systems and/or software to customize the computer system suited to his or her functional requirements. In addition, because the hard disks could only handle several hundred mega-bytes of information, most of the data had to be stored in floppy diskettes. Accordingly, data lost with the computer could be reloaded into the new computer. Because of the small capacity of the hard disks, huge information databases had been kept in a series of magnetic tapes and run only by a main-frame computer. Thus, there was no practical possibility that a loss of single computer resulted in a loss of vast amount of information.

To the contrary, today's computers come with hard disks capable of storing, e.g., at least several hundred giga-bytes of information. In addition, today's users tend to generate and store a lot of information in the hard disk and/or download vast amounts of information directly from the internet. Thus, it is virtually impossible to keep a library of floppy disks as a back-up system for the information stored in the hard disk. In order to accommodate such dramatic changes in hardware technology, a high-capacity back-up system, e.g., a ZIP drive, has been introduced to the market. If used appropriately, a loss of information due to the loss of the computer can easily be remedied by dumping back the data in the ZIP drive into a hard disk of a new computer.

Such a remedy is not amenable at all, however, if the information stored in a lost computer is highly confidential in its nature. In many cases, a loss of capital due to the lost hardware is negligible in its magnitude if compared with that of the lost, invaluable information. Even if the confidential information may be reloaded into a new computer from a properly maintained back-up system, the loss of such information cannot be remedied in case the information should end up in the wrong hands. The user would wish that he or she would have crushed the piece of hardware rather than would deliver it to his competitor or mortal enemy.

Accordingly, there is an impending need for protecting information stored in the computer from being accessed by an unauthorized intruder, even through sacrificing the hardware of the computer.

### SUMMARY OF THE INVENTION

The present invention generally relates to a computer security system capable of preventing an unauthorized intruder from retrieving information from the computer by degrading the information stored in an information processing system of the computer.

In one aspect of the invention, a computer protects information stored in a hard disk thereof from being accessed by an unauthorized user. The computer includes an access control system and a guard system. The access control system may be arranged to detect unauthorized attempt to access the information and to generate a protection command signal responsive to such attempt. The guard system is arranged to degrade at least a portion of the information stored in the hard drive responsive to the protection command signal.

In another aspect of the invention, a computer protects information stored therein from being accessed by an unauthorized user. The computer generally includes at least one information storage system capable of storing information. The computer further includes an access control system, and a guard system both of which are substantially identical to those described above.

In yet another aspect of the invention, a computer protects information processed thereby from being accessed by an unauthorized user. The computer generally includes at least one information processing system capable of processing information, an access control system capable of detecting unauthorized attempt to access the information and generating a protection command signal responsive to such attempt, and a guard system capable of degrading at least a portion of the information responsive to the protection command signal.

The secure computer of the present invention offers numerous advantages. First of all, the secure computer guarantees prevention of information retrieval by an intruder. Because the information stored in the computer itself is at least partially degraded, even if the intruder can somehow extract such information, it is not in a retrievable format. In addition, depending on the degradation mechanism, the degradation may be undone by an authorized user by, e.g., performing the degradation steps in a reverse order. Thus, if desirable, the user can retrieve the useful information by undoing the degradation steps. Furthermore, the information storage and/or processing system may remain functionally intact even after the degradation of information stored therein or processed thereby. Accordingly, such information storage or processing system may be regenerated and reused.

Embodiments of this aspect of the invention may include one or more of the following features.

The information processing system generally includes at least one information storage unit. The information processing system may also include an information read-only unit, an information write-only unit, and/or an information read/write unit. The information is generally stored in the information storage unit as a plurality of magnetic bands formed on a surface of the information storage unit. Examples of information stored in the information storage unit may include, but not limited to, a digitized program, digitized datum, digitized sound, and/or digitized image. Examples of the information storage unit may include, but not limited to, a hard disk, a floppy disk, and/or a magnetic tape. Examples of the information read/write unit may include, but not limited to, a hard disk driver, a floppy disk driver, and/or a magnetic tape driver.

The access control system generally includes an input receiving unit and a logic unit. The input receiving unit receives a log-in input. The logic unit then determines validity of the log-in input, and provides access to the computer when the log-in input is valid, but sends the protection command signal to the guard system when the log-in input is invalid. At least one of the input receiving unit and the logic unit may be arranged to receive at least two log-in inputs before the logic unit sends the protection signal to the guard system.

The computer may further include a display monitor and a memory device storing benign images. At least one of the input receiving unit and logic unit may be arranged to display one of the benign images on the display monitor even after the logic unit detects the log-in attempt by the unauthorized user and sends the protection command signal to the guard system. This embodiment is expected to provide requisite time for the guard system to degrade the information stored in the information storage unit.

The guard system may include a signal receiving unit and an eraser unit. The signal receiving unit is arranged to receive a command signal from the access control system, e.g., the protection command signal. The eraser unit is arranged to degrade at least a portion of information stored in the information storage unit.

The eraser unit is generally disposed adjacent to the information storage unit and includes at least one chamber having therein at least one chemical substance capable of altering magnetic property of the information storage unit. Responsive to the protection command signal, the eraser unit delivers the chemical substance from the chamber to the information storage unit, thereby degrading at least a portion of the information stored in the information storage unit. The eraser unit may further include a motion device which can move the eraser unit while the eraser unit delivers the chemical substance from the chamber to the information storage unit. This embodiment may allow a smaller eraser unit to degrade a larger portion of the information storage unit.

The eraser unit may also be disposed adjacent to the information storage unit and include at least one chamber having therein at least one another chemical substance capable of forming a substantially non-peelable bonding with at least a portion of the information storage unit. The eraser unit may further include a motion device which can move the eraser unit while the eraser unit delivers the another chemical substance from the chamber to the information storage unit.

The eraser unit may further be disposed adjacent the information storage unit and include at least one member capable of mechanically deforming the information storage unit upon contact therewith. In the alternative, the eraser unit may further be disposed adjacent to the information storage unit and generate magnetic field around at least a portion of the information storage unit responsive to the protection command signal.

The guard system may include a motion device capable of moving at least one of the eraser unit and the information storage unit with respect to the other of the erasure unit and the information storage unit. The eraser unit may also include a motion device capable of moving the eraser unit while the eraser unit performs mechanical degradation of the information storage unit or generates magnetic field around the information storage unit.

In another aspect of the invention, a computer hard disk unit may include at least one hard disk and at least one read/write head therein. The hard disk unit may include at least one of the following: a chamber having therein at least one first chemical substance capable of altering or degrading magnetic property of at least a portion of the hard disk; another chamber having therein at least one second chemical substance capable of forming a substantially non-peelable bonding with at least a portion of the hard disk; a first mechanical member capable of scraping a surface of at least a portion of the hard disk upon contact therewith; a second mechanical member capable of changing a shape of at least a portion of the hard disk upon contact therewith; a third mechanical member capable of breaking at least a portion of the hard disk upon contact therewith; a permanent magnet capable of contacting with at least a portion of the hard disk; and an electric magnet capable of generating magnetic field around at least a portion of the hard disk when supplied with electric power. These hard disk units protect the information processed by the information processing system of the computer from being retrieved by the unauthorized intruder.

Embodiments of this aspect of the invention may include one or more of the following features.

The hard disk unit may further include a power supply for supplying electric power to the electric magnet. In the alternative, the hard disk unit may be arranged to generate requisite mechanical and/or electric power from rotational motion of a shaft of a hard disk driver.

In yet another aspect of the invention, a floppy disk may include therein at least one of the following: a chamber having therein at least one first chemical substance capable of altering or degrading magnetic property of at least a portion of the floppy disk; another chamber having therein at least one second chemical substance capable of forming a substantially non-peelable bonding with at least a portion of the floppy disk; a first mechanical member capable of scraping a surface of at least a portion of the floppy disk upon contact therewith; a second mechanical member capable of changing a shape of at least a portion of the floppy disk upon contact therewith; a third mechanical member capable of breaking at least a portion of the floppy disk upon contact therewith; a permanent magnet capable of contacting with at least a portion of the floppy disk; and an electric magnet capable of generating magnetic field around at least a portion of the floppy disk when supplied with electric power. These floppy disks can protect the information stored therein from being retrieved by the unauthorized intruder.

Embodiments of this aspect of the invention may include one or more of the following features.

The floppy disk may further include a miniature power supply which may supply electric power to the electric magnet. Alternatively, the floppy disk may be arranged to generate requisite mechanical and/or electric power from rotational motion of a shaft of a floppy disk driver.

In another aspect of the invention, a method is provided to protect information stored in a hard disk of a computer from being accessed by the unauthorized intruder. The method generally includes the steps of detecting unauthorized attempt to access the information and degrading at least a portion of the information stored therein.

In yet another aspect of the invention, another method is provided for protecting information stored in a computer from being accessed by an unauthorized intruder. This method generally includes the steps of detecting unauthorized attempt to access the information and, upon detecting the unauthorized attempt, degrading at least a portion of the information stored in the computer.

In yet another aspect of the invention, another method is provided for protecting information processed by a computer from being accessed by an unauthorized intruder. The method generally includes the steps of detecting unauthorized attempt to access the information and, upon detecting the unauthorized attempt, degrading at least a portion of the information.

Embodiments of this aspect of the invention may include one or more of the following features.

The detecting step may further include the steps of receiving a log-in input and determining validity thereof. Alternatively, the detecting step may include the steps of sensing a disassembly of the computer which may result in exposing an interior of the computer and determining validity of such disassembly.

The degrading step may include the steps of contacting at least a portion of the information processing system with at least one first chemical substance and altering chemical property thereof. Alternatively, the degrading step may include the steps of contacting at least a portion of the information processing system with at least one second chemical substance and altering mechanical property thereof. The degrading step may further include the steps of contacting at least a portion of the information processing system with at least one third chemical substance and altering magnetic property thereof.

The magnetically altering step may include at least one of the steps of randomly altering the magnetic property and systematically altering the magnetic property. The systematically altering step may include the step of storing a pattern of the systematic alteration such that the systematic alteration can be undone thereafter.

In yet another aspect of the invention, another method is provided for protecting information stored in a hard disk of a computer. The method may include at least one of the steps of storing at least one first chemical substance adjacent to the hard disk and contacting the first chemical substance with at least a portion of the hard disk where the first chemical substance can alter magnetic property of the hard disk; storing at least one second chemical substance adjacent the hard disk and contacting the second chemical substance with at least a portion of the hard disk where the second chemical substance can form a substantially non-peelable bonding with the hard disk; scraping at least a portion of a surface of the hard disk; deforming a shape of the hard disk; breaking at least a portion of the hard disk; disposing at least one permanent magnet and moving the magnet adjacent at least a portion of the hard disk; and providing at least one electric magnet around at least a portion of the hard disk and supplying electric current through the electric magnet, thereby generating a magnetic field around the portion of the hard disk.

In yet another aspect of the invention, another method is provided for protecting information stored in a floppy disk. The method may include at least one of the steps of storing at least one first chemical substance adjacent the floppy disk and contacting the first chemical substance with at least a portion of the floppy disk where the first chemical substance is capable of altering magnetic property of the floppy disk; storing at least one second chemical substance adjacent the floppy disk and contacting the second chemical substance with at least a portion of the floppy disk where the second substance can form a substantially non-peelable bonding with the floppy disk; scraping at least a portion of a surface of the floppy disk; deforming a shape of the floppy disk; breaking at least a portion of the floppy disk; disposing at least one permanent magnet and moving the magnet adjacent at least a portion of the floppy disk; and providing at least one electric magnet inside at least a portion of the floppy disk and supplying electric current therethrough, thereby generating a magnetic field around the portion of the floppy disk.

As used herein, the term “processing” generally means reading, writing, storing, retrieving or manipulating information. Similarly, the phrase “information processed” generally means the information which has already been processed, which is currently being processed, and/or which will be processed by the computer.

“Information” generally refers to any intangible substances related to computer source codes, computer data such as technical, scientific, financial, organizational, and/or audiovisual information including, but not limited to, digitized sound and images. “Information” may be processed in various formats, e.g., in an ASCII code, binary code, and other formats conventionally used in digital computers, microchips, and/or their equivalents.

An “unauthorized attempt” to, e.g., access information processed by the computer generally means any attempt by an unauthorized user. Examples of such “attempt” may include, but not limited to, supplying an invalid log-in input, hacking into an information processing system of the computer, disassembling or breaking the computer to acquire physical access to the information processing system of the computer. It is appreciated, however, that the criteria for the authorized and unauthorized attempt may be determined depending on the circumstances. Accordingly, the logic for identifying such attempts may be tailored by the user and may differ significantly from one case to the other.

Unless otherwise defined in the specification, all technical and scientific terms used herein have the same meaning as commonly understood by one of ordinary skill in the art to which the present invention belongs. Although methods and/or materials equivalent or similar to those described herein can be used in the practice or testing of the present invention, suitable methods and/or materials are described below. All publications, patent applications, patents, and/or other references mentioned herein are incorporated by reference in their entirety. In case of conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIG. 1 is a schematic diagram of one embodiment of a secure computer according to the present invention.

FIG. 2 is a schematic diagram of one embodiment of an access control system of a secure computer according to the present invention.

FIG. 3 is a schematic diagram of one embodiment of a guard system of a secure computer according to the present invention.

FIG. 4 is a perspective view of a conventional hard disk unit.

FIG. 5 is a perspective view of one embodiment of a guard system of the present invention.

FIG. 6 is a perspective view of another embodiment of a guard system of the present invention.

FIG. 7 is a perspective view of yet another embodiment of a guard system of the present invention.

### DETAILED DESCRIPTION

The present invention generally relates to a computer security system capable of degrading information processed by the computer before an intruder obtains an access thereto, thereby deterring the intruder from retrieving the confidential information stored in the computer.

FIG. 1 is a schematic diagram of one embodiment of a secure computer according to the present invention. For simplicity, a computer 100 is represented by two functional units, i.e., a CPU 110 and an information processing system 120. Provided with the computer 100 is a computer security system 200 including an access control system 300 and a guard system 400. The access control system 300 is functionally coupled with the CPU 110 and/or the information processing system 120, and may be arranged to detect an unauthorized attempt to access the information processed by the computer 100. The guard system 400 is also functionally coupled with the CPU 110 and/or the information processing system 120, and may be arranged to degrade at least a portion of information processed by the computer 100. Although not included in FIG. 1, the information processing system 120 may include an information storage unit, information read-only unit, information write-only unit, and/or information read/write unit. Examples of such units may include, but not limited to, a hard disk and a hard disk driver, a floppy disk and a floppy disk driver, a magnetic tape and a magnetic tape driver, and other conventional information processing devices utilizing electric, magnetic, and/or optical properties.

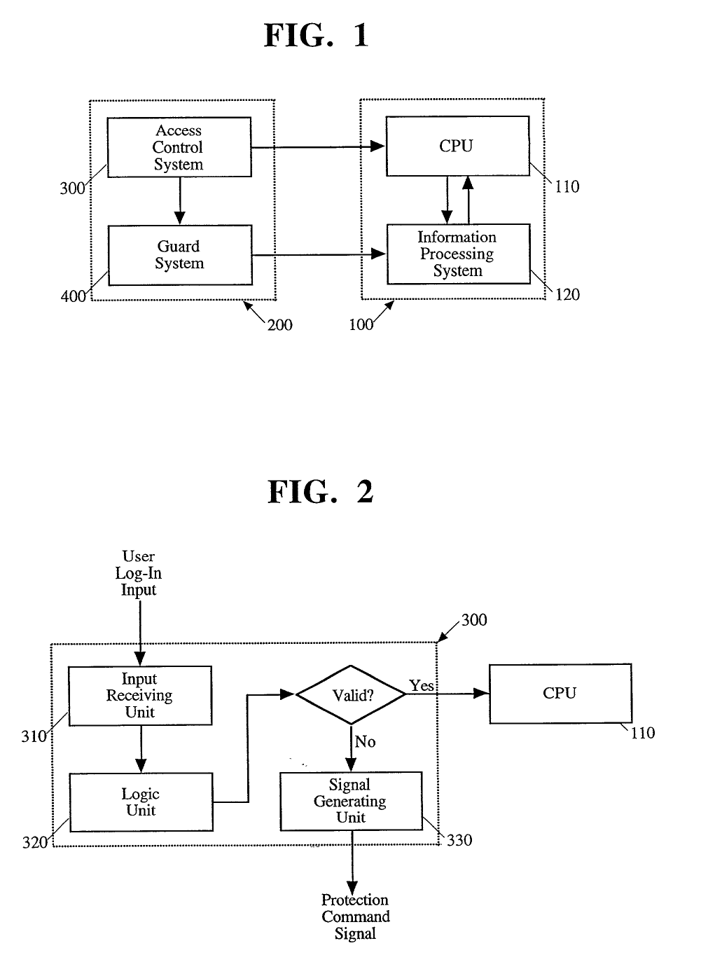

FIG. 2 is a schematic diagram of the access control system 300 according to the present invention. The access control system 300 typically includes an input receiving unit 310, a logic unit 320, and a signal generating unit 330. The input receiving unit 310 is generally arranged to receive a log-in input from an user and passes the input to the logic unit 320. The logic unit 320 then determines whether the log-input is valid, e.g., by comparing the log-in input with a list of authorized inputs. When the log-in input is valid, the logic unit 320 provides the user with an access to the CPU 110 and/or the information processing system 120. However, when the log-in input is invalid, the logic unit 320 activates the signal generating unit 330 which in turn generates a protection command signal and transmits it to the guard system 400 which will be discussed in greater detail below.

It is appreciated that the input receiving unit 310 and the logic unit 320 may be combined into a single unit. In the alternative, the signal generating unit 330 may also be combined with one or both of the input receiving unit 310 and the logic unit 320. Other equivalent structures may be employed as long as the access control system 300 can detect an unauthorized attempt to log in to the computer 100. Detailed architecture of the access control system 300 is generally a matter of choice that largely depends on a design selection made by one of ordinary skill in the art.

It is also appreciated that the input receiving unit 310 and/or the logic unit 320 may be arranged to provide the user more than one opportunity to provide the valid log-in input. For example, when the user supplies an invalid log-in input, one of the input receiving unit 310 and/or the logic unit 320 may allow the user to provide a second login input. In the alternative, the input receiving unit 310 and/or the logic unit 320 may also be arranged to receive more than one type of log-in input. For example, these units may be arranged to detect a wireless signal emitted by a transmitting device worn by an authorized user. Accordingly, when the user wearing the device is in proximity of the computer 100 and when the user provides the valid log-in input, the logic unit 320 may allow the user to access the computer 100. In another example, the logic unit 320 may be used in combination with other conventional security systems such as retina and/or finger-print recognition systems. Only when the conventional security system and the logic unit 320 both recognize the valid authorized identity, the user is provided an access to the computer 100.

It is further appreciated that the logic unit 320 may be arranged to detect other forms of unauthorized attempts to access the information processing system 120 of the computer 100. For example, the logic unit 320 may include one or more sensors (not shown) sensing disassembly which may physically expose the information processing system 120 and/or the interior thereof to the intruder. For example, sensors such as a linear displacement sensor or force transducer may be disposed inside the computer 100 and sense unauthorized opening of a case of the computer 100. In order to determine whether the case is opened by an authorized maintenance and/or repair person or by an unauthorized intruder, a control software may be installed to the logic unit 320 such that it may receive an authorization password or the log-in input, from the authorized person. If the user supplies an invalid password or log-in input for disassembly, the logic unit 320 may activate the signal generating unit 330 to generate the protection command signal.

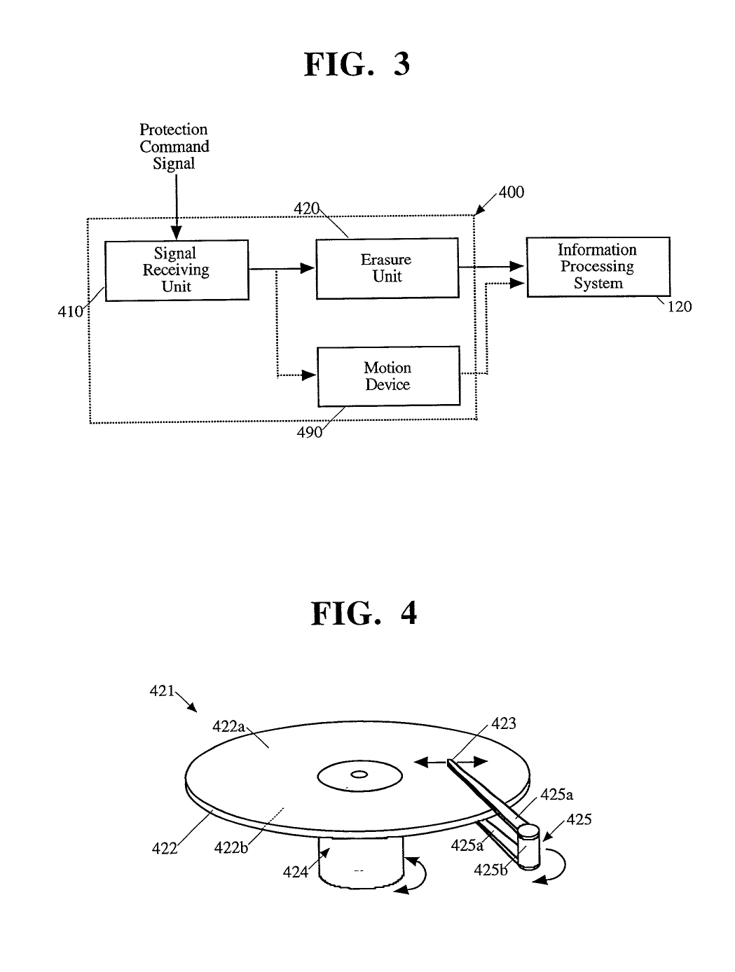

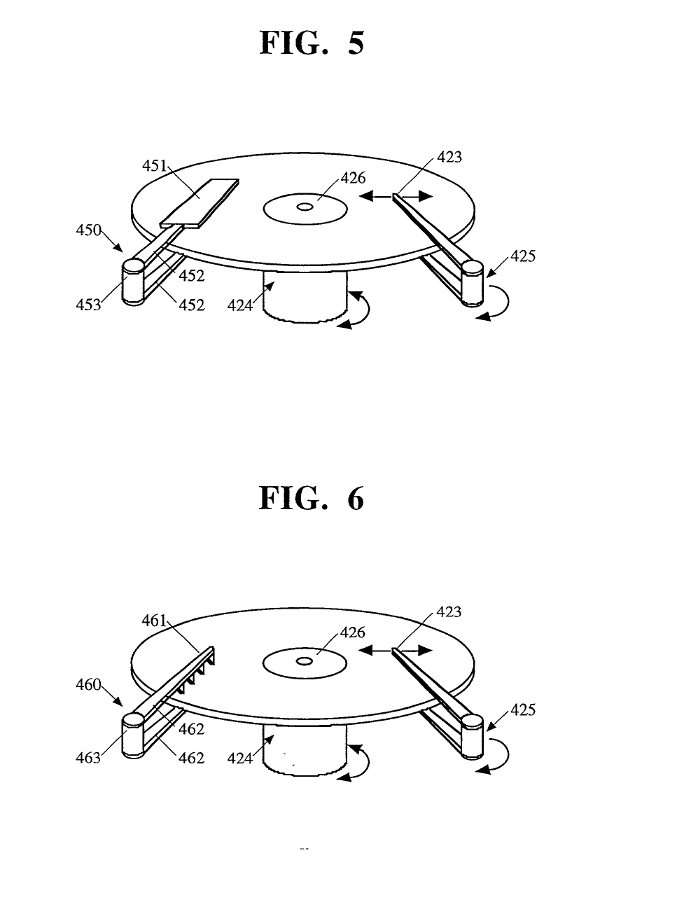

FIG. 3 is a schematic diagram of one embodiment of the guard system 400 according to the present invention. The guard system 400 typically includes a signal receiving unit 410, an eraser unit 420, and an optional motion device 490. The signal receiving unit 410 is arranged to receive a command signal, e.g., the protection command signal, transmitted by the signal generating unit 330 of the access control system 300. The signal receiving unit 410 then activates the eraser unit 420 which deforms at least a portion of the information processed by the information processing system 120 of the computer 100. The optional motion device 490 may be arranged to move the eraser unit 420 during the degradation step. Different mechanisms may be incorporated into the eraser unit 420 for degrading the information processed by the computer 100. FIGS. 5 through 7 illustrate several different exemplary embodiments of such erasure units 420 in greater details. Although the embodiments in FIGS. 5 to 7 are directed to the eraser unit 420 for a hard disk unit, they are intended to illustrate and not limit the scope of the invention.

FIG. 4 is a perspective view of a conventional hard disk unit 421 (such as the information processing system 120) of the computer 100 having one magnetic hard disk 422 (such as the information storage unit), two information read/write heads 423 (such as the information read/write units) each being disposed on a top surface 422a and a bottom surface 422b of the hard disk 422, a disk driver 424 arranged to rotate the hard disk 422, and a head driver 425 arranged to laterally move the information read/write heads 423. The hard disk 422 typically stores information therein by forming therealong multiple magnetic bands. The read/write heads 423 contain metal coils wound around a metal core made of, e.g., iron, and are disposed adjacent the surfaces 422a, 422b of the bard disk 422. When the hard disk unit 421 operates in a read mode, the read/write heads 423 are disposed adjacent the magnetic bands formed on the surfaces 422a, 422b of the hard disk 422 which is rotated by the disk driver 424. The magnetic bands then induce electric current through the coils of the read/write heads 423 that is converted into the bit-wise information. When the hard disk unit 421 operates in a write mode, electric current is fed to the coils of the read/write heads 423 according to a sequence of the information to be written on the hard disk 422. The current-flowing coils generate a magnetic field therearound and magnetizes one or both surfaces 422a, 422b of the hard disk 422. During the read and/or write operations, the disk driver 424 rotates the hard disk 422 to facilitate the reading and/or writing of information. The head driver 425 is arranged to move the read/write heads 423 back and forth across the top and/or bottom surfaces 422a, 422b of the hard disk 422 so that the read/write heads 423 can access all areas of the top and/or bottom surfaces 422a, 422b of the hard disk 422 available for processing the information. The embodiment shown in FIG. 4 further includes a pivot 425b and arms 425a. The arms 425a connect the read/write heads 423 to the pivot 425b. By arranging the rotatable pivot 425b, the arms 425a and the read/write heads 423 can access different areas across the hard disk 422. The hard disk unit 421 is generally disposed in a case (not shown) to exclude the dust. It is appreciated that the conventional hard disk unit having configurations different from the one illustrated in FIG. 4 may also be used. For example, the disk unit may include two or more hard disks and three or more read/write heads.

FIG. 5 is a perspective view of one embodiment of a first eraser unit 450 of the present invention. The eraser unit 450 typically includes at least one storage chamber 451 containing at least one chemical substance that is capable of changing or degrading the magnetic property of a portion of the hard disk 422 being contacted therewith. For example, fluoride and/or bromide compounds may be stored in the storage chamber 451. Upon receiving the protection command signal from the signal generating unit 330 of the access control system 300, the first eraser unit 450 delivers the chemical substance to the surfaces 422a, 422b of the hard disk 422 such that the substance may etch away the outer layers of the surfaces 422a, 422b of the hard disk 422 along with the information encoded in the magnetic bands thereof. The storage chamber 451 may also be attached to auxiliary arms 452 which extend toward a rotatable hinge 453 such that the storage chamber 451 moves across the hard disk 422 and degrades a substantial portion of the information stored therein.

Although not shown in the figure, the storage chamber 451 may also be disposed adjacent a rotating shaft 426 of the disk driver 424. In operation, upon receiving the protection command signal, the chemical substance may be released from the storage chamber 451 toward the rotating shaft 426 and dispersed across the surface 422a, 422b of the hard disk 422. The centrifugal force generated by the rotating hard disk 422 may facilitate the distribution of the chemical substance across the hard disk 422. A fluid pathway (not shown) may also be provided around or inside the rotating shaft 426 such that the chemical substance may be delivered therethrough. When two or more hard disks 422 are stacked along the rotating shaft 426, this embodiment may be beneficial in delivering the chemical substance to each of the hard disks 422. In the alternative, the storage chamber 451 may be attached to an interior of the case (not shown) or to the arms 425a of the read/write heads 423 so that the chemical substance may be delivered onto the surfaces 422a, 422b of the hard disk 422.

Different chemical substances may be used depending on the material of the hard disk 422 and/or the necessary degree of degradation of the information stored in the hard disk 422. Examples of such chemical substances may include, but not limited to, organic and/or inorganic solvents, etchants conventionally used in silicon fabrication in the semi-conductor industry, and any material capable of changing magnetic property of the surfaces 422a, 422b of the hard disk 422, e.g., corrosive and/or magnetic substances. For example, magnetic metal powder mixed with an optional adhesive may be sprayed onto the surfaces 422a, 422b of the hard disk 422, thereby altering the coding pattern of the magnetic bands. In the alternative, a corrosive agent may be sprayed onto the surfaces 422a, 422b of the hard disk 422, thereby degrading the magnetic property of the hard disk 422 and destroying the information stored therein. Yet another example is a chemical substance which can form a non-peelable bond with the surfaces 422a, 422b of the hard disk 422. Any attempt to remove the bond will result in destruction of the magnetic encoding on the surfaces 422a, 422b of the hard disk 422, thereby preventing the intruder from retrieving the information from the hard disk 422. It is appreciated that these chemical substances may be used in any forms of liquid, gel, foam, gas, vapor, spray, particulate, solid, particles, and/or any mixture thereof. Selecting an appropriate chemical substance and/or its delivery mechanism is generally a matter of choice of one with ordinary skill in the art. When a toxic chemical substance is used, the guard system 450 may include an auxiliary storage chamber which contains an neutralizer. Thus, after completing the degradation step, the neutralizer is delivered to the hard disk 422 and removes toxicity of the left-over toxic substances.

FIG. 6 is a perspective view of one embodiment of a second eraser unit 460 of the present invention. The second eraser unit 460 typically includes at least one mechanical member 461 which is capable of mechanically deforming the hard disk 422 upon contact therewith. For example, multiple sharp blades 461 may be provided along auxiliary arms 462 which are connected to a rotatable pivot 403. The blades 461 are initially disposed at a certain distance from the surfaces 422a, 422b of the hard disk 422. Upon receiving the protection command signal from the signal generating unit 330 of the access control system 300, the second eraser unit 460 lowers the blades 461 onto the surfaces 422a, 422b of the hard disk 422 and maintains the contact therebetween such that the blades 461 may scrape away outer layers of the surfaces 422a, 422b of the hard disk 422 along with the information encoded therein as the magnetic bands. The blades 461 may also be arranged to travel across the surfaces 422a, 422b of the hard disk 422 so that a small number of blades 461 deform at least a substantial portion of the surfaces 422a, 422b of the hard disk 422 available for storing the information. Although not illustrated in the figure, the mechanical member 451 may be disposed adjacent a rotating shaft 426 of the disk driver 424 and/or any other location inside the hard disk unit 421. For example, the mechanical member 421 may be attached to an interior of the case (not shown) and/or the arms 425a of the read/write head 423. By providing appropriate actuating and/or motion devices, these mechanical members 421 mechanically deform the surfaces 422a, 422b of the hard disk 422.

It is appreciated that the mechanical member 461 may have various shapes and sizes depending on the material of the hard disk 422 and/or the necessary degree of degradation of the information stored in the hard disk 422. For example, the mechanical member 461 may be shaped and sized as a razor blade, drill bit, chisel, scraper, and/or other conventional objects used for changing the shape and/or size of metal, mineral, and/or plastic materials. Furthermore, the mechanical member 461 may also be arranged to exert force on the hard disk 422 such that at least a portion of the hard disk 422 is damaged by the resulting force. In another embodiment, the eraser unit 460 may include a heating element which is capable of heating and deforming at least a portion of the information storage unit. This embodiment is best applied to the information storage unit made of non-silicon material, for the melting point of silicon compounds exceed 1,000° C. It is appreciated that selecting an appropriate mechanical element and/or accompanying motion device thereof is generally a matter of choice of one with ordinary skill in the art.

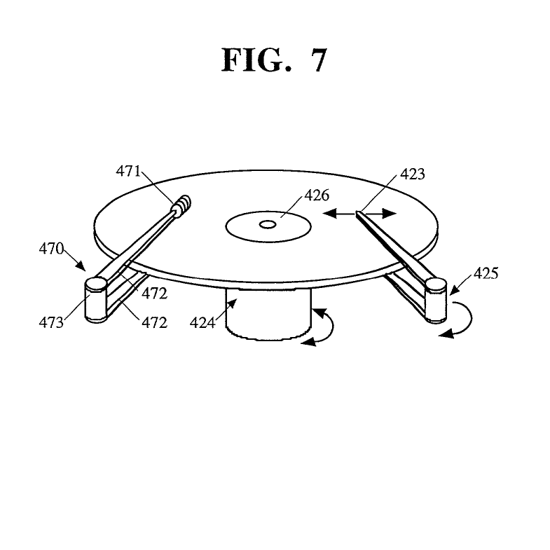

FIG. 7 is a perspective view of one embodiment of a third eraser unit 470 of the present invention. The eraser unit 470 typically includes at least one electric magnet 471 disposed adjacent to the surfaces 422a, 422b of the hard disk 422. Upon receiving the protection command signal from the signal generating unit 330, the third eraser unit 470 is fed with electric current so that the electric magnet 471 generates magnetic field therearound, thereby erasing, altering, changing, and/or deforming coding patterns of the magnetic bands formed on the surfaces 422a, 422b of the hard disk 422. The electric magnet 451 may be attached to auxiliary arms 472 of a rotatable hinge 473 such that the electric magnet 471 may move across the hard disk 422 while degrading a substantial portion of the information stored in the hard disk 422. Although not illustrated in the figure, the electric magnet 471 may also be disposed adjacent a rotating shaft 426 of the disk driver 424. In the alternative, the electric magnet 471 may also be attached to an interior of the case (not shown) and/or the arms 425a of the read/write heads 423. In addition, the electric magnet 471 may also be arranged to form coils around the hard disk 422 such that at least a substantial portion of the hard disk 422 may be subject to the magnetic field generated thereby.

In another embodiment, the read/write heads 423 of the hard disk unit 421 may be recruited to magnetically degrade the information stored on the surfaces 422a, 422b of the hard disk 422. For example, the eraser unit 470 may be arranged to manipulate the read/write heads 423 to change the coding patterns of the magnetic bands formed on the surfaces 422a, 422b of the hard disk 422. Accordingly, all of the magnetic bands may be reset to bit information corresponding to “0” or “1,” e.g., such as the case of the initialization of the hard disk 422. In the alternative, the read/write heads 423 may be arranged to randomly or systematically alter the coding patterns of the magnetic bands on the surfaces 422a, 422b of the hard disk 422. This may be done in a selected or an entire portion of the surfaces 422a, 422b of the hard disk 422. In particular, when the read/write heads 423 is arranged to perform the systematic degradation, the eraser unit 470 may be arranged to manipulate the read/write heads 423 to change the coding patterns of the magnetic bands according to a pre-determined pattern of degradation. For example, the read/write heads 423 may be arranged to reverse the direction of every third magnetic band. This embodiment offers the benefit of reconstructing the degraded hard disk 422 by a valid user. For example, by using this pre-determined degradation pattern, the degraded portion of the hard disk 422 can be reverted back into its original coding patterns. The portion of the computer 100 storing this pre-determined pattern is preferably arranged to be degraded as well in order to prevent the intruder from perform the reconstruction of the hard disk 422.

It is appreciated that the electric magnet 471 of the third eraser unit 470 may be activated by external power and/or by an internal power supply (not shown) which may be disposed inside the computer 100 or inside the hard disk unit 421 itself. Accordingly, even when the intruder succeeds in disconnecting the external power supply from the hard disk unit 421, the guard system 400 can actuate the erasure unit 470 to deform the information stored in the hard disk 422. The similar embodiments may also be applied to other erasure units 450, 460 as well.

It is also appreciated that a permanent magnet may also be used in the eraser unit 470 described above. Use of the permanent magnet, however, requires an additional provision that the magnetic field constantly generated by the permanent magnet must be insulated from the hard disk 422 as well as other internal components of the computer 100 of which the performance is adversely affected by the presence of the magnetic field therearound. Thus, the permanent magnet may be contained in an insulating chamber and moved adjacent to the surfaces 422a, 422b of the hard disk 422 only during the degradation step. Such insulation chambers may be made of or coated with a magnetic insulation material known in the art.

It is further appreciated that the guard system 400 may include a control software capable of maintaining proper operation of the guard system 400 during the degradation operation. The control software may also be arranged to maintain normal mechanical operations of the other parts of the computer 100, for example, the hard disk 422, the hard disk driver 424, the read/write heads 425, and the like. Because the degradation operation sooner than later disrupts an operating system of the computer, the hard disk 422 may stop spinning or the read/write heads 425 may cease to move. As described above, when the eraser unit 450, 460, 470 is disposed at the rotating shaft 426 of the hard disk 422, when the operation of the eraser unit 450, 460, 470 is at least partially dependent on the movement of the hard disk 422 or read/write heads 425, or when the source code for operation of the eraser unit 450, 460, 470 is encoded and/or stored in the hard disk 422, the eraser unit 450, 460, 470 may cease to operate as well as soon as the operating system of the computer 100 starts to malfunction. Thus, it is preferred that the guard system 400 and the eraser units 450, 460, 470 thereof be arranged such that they can operate independently of the status of the other parts of the computer 100. One way of accomplishing this embodiment may be to provide an independent control software and an optional power supply therefor. Accordingly, even when a substantial portion of the operating system of the computer 100 is degraded, the control software may operate the erasure units 450, 460, 470 while maintaining spinning of the hard disk 422 and/or lateral movement of the read/write heads 425.

In addition, the guard system 400 may be provided with another control software capable of displaying benign images on a display device coupled to the computer 100. For example, when the guard system 400 receives the protection command signal from the signal generating unit 330, the guard system 400 may activate the control software such that the display device displays a camouflage images thereon. Example of such images may include, but not limited to, an initial screen for Window OS or MacIntosh OS thereon. These images will allude the intruder into believing that the computer 100 is booting up. Alternatively, the display device may display other messages, e.g., that the computer 100 is to be accessed in a stand-alone mode due to a failure of providing a valid log-in input. By displaying these seemingly benign images, an intruder will likely be alluded into believing that he or she will soon be provided an access to the computer 100 and will not be able to comprehend the protective action being performed by the above-described guard system 400 and the eraser units 450, 460, 470 thereof. Thus, the guard system 400 is more likely to accomplish its task while preventing the intruder from taking anti-protective or evasive action of his or her own.

It is also appreciated that the guard system 400 may include more than one eraser units 450, 460, 470 to facilitate effective degradation of the information processed by the information processing system 120. For example, the guard system 400 may include the chemical erasure unit 450 in addition to the magnetic eraser unit 470 therein. By incorporating multiple independent degradation mechanisms, the time for degrading a pre-determined portion of the hard disk 422 may be reduced, e.g., by 50% or more. In addition, a single internal power supply may be able to power more than one eraser units 450, 460, 470.

In another aspect of the invention, a computer hard disk unit (including a hard disk driver and at least one hard disk therein) or a floppy disk unit (including a floppy disk driver capable of receiving a floppy disk thereto) may be arranged to include at least some of the above-described features of the access control system 300 and/or the guard system 400. For example, a hard disk unit may include therein the access control features such that the hard disk unit can detect an unauthorized attempt to disassemble the unit and to expose the hard disk thereof. The hard disk unit may also include at least one of the guard features described above such that the unauthorized disassembly of an external housing of the hard disk unit may initiate one of the degradation processes described heretofore. It is preferred that such hard disk unit include an internal power supply enabling the guard system to perform the degradation of the hard disk. A floppy disk unit may also be arranged to include similar features of the access control system 300 and guard system 400 so that an unauthorized disassembly of the floppy disk unit to access the floppy disk may initiate one of the above-described degradation processes. It is appreciated, however, that not every aspect of the access control system 300 and guard system 400 may have to be incorporated into such hard disk unit and/or floppy disk unit, and that it is a matter of choice of one of ordinary skill in the art to determine what aspects to be incorporated thereinto and what else aspects to be excluded and disposed external to the hard disk unit and/or the floppy disk unit.

Although the figures and accompanying illustration heretofore have been mainly directed toward the computer hard disk and its driver assembly, the present invention may also be applied to other information processing systems. Examples of such systems include, but not limited to, a floppy disk/driver, a magnetic tape/driver, a memory chip such as a ROM (read-only memory), a RAM (random-access memory), and a non-volatile memory such as a flash memory, a compact disk/driver including CD-R (CD recordable) and CD-RW (CD rewritable), an optical or laser disk/driver including recordable and rewritable ones. These aspects of the invention are now discussed in greater details.

For example, in another aspect of the invention, a floppy disk may be arranged to include at least some of the above-described features of the access control system 300 and the guard system 400. Such floppy disk may include the access control features so that it has been inserted into an unauthorized floppy disk driver. In the alternative, the floppy disk may also be arranged to detect an unauthorized attempt to disassemble it and to expose a magnetic disk thereof. The floppy disk may also include at least one of the guard features described above so that the unauthorized insertion or disassembly of the floppy disk may initiate one of the degradation processes described heretofore. It is preferred that such floppy disk unit include an internal power supply enabling the guard system to perform the degradation of the floppy disk. Alternatively, the floppy disk may be arranged to extract mechanical and/or electrical energy from the unauthorized floppy disk driver, e.g., through its read/write heads or through its rotating shaft or its rotational motion. Detecting the unauthorized insertion of the floppy disk may be accomplished by various configurations. For example, the floppy disk may be provided with a sensor capable of recognizing at least one of unique features provided to the authorized floppy disk driver. Examples of such unique features may include, but not limited to, an unique structure along an intake pathway of the driver such as a latch or protrusion therealong, pre-determined electric or magnetic coding on or along a read/write head of the driver, and other security technologies known in the art.

In another aspect of the invention, a guard system may be arranged to alter and/or degrade information stored in a ROM. For example, by disposing one or more of the eraser units 450, 460, 470 adjacent the ROM, the information stored in the ROM may be degraded chemically, mechanically, and/or magnetically. Because the ROM is generally provided by a protective cover disposed thereon, the chemical eraser unit 450 may be the preferred choice.

In yet another aspect of the invention, a guard system may further be arranged to degrade information stored in volatile memory devices such as a RAM and/or other non-volatile memory devices such as a flash memory. For example, the guard system 400 may be electrically connected to those memory devices such that the guard system 400 may disconnect power supply thereto and/or supply sufficiently high current which may alter or disrupt capacitive properties of such devices.

In yet another aspect of the invention, an optical and/or laser disks may also be protected by a guard system. The guard system may be provided with at least one laser gun capable of emitting laser beams. Upon receiving a protection command signal from the signal generating unit 330 of the access control system 300, the guard system fires laser beams onto the tracks formed on the surfaces of such disks. The intensity of the laser beams may be adjusted such that the beams leave dark marks on the tracks, thereby degrading the information retrieved by an optical and/or laser disk drive.

It is to be understood that while the present invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A computer capable of protecting information stored in a hard disk thereof from being accessed by an unauthorized user comprising:
an access control system capable of detecting unauthorized attempt to access said information and generating a protection command signal responsive to said attempt; and
a guard system capable of degrading at least a portion of said information responsive to said protection command signal.

2. A computer capable of protecting information processed thereby from being accessed by an unauthorized user comprising:
at least one information processing system for processing said information;
an access control system capable of detecting unauthorized attempt to access said information and generating a protection command signal responsive to said attempt; and
a guard system capable of degrading at least a portion of said information responsive to said protection command signal.

3. The computer according to claim 2, wherein said information processing system comprising at least one information storage unit and further comprising at least one of:
an information read-only unit;
an information write-only unit; and
an information read/write unit.

4. The computer according to claim 3 wherein information is stored in said information storage unit as a plurality of magnetic bands formed on a surface of said information storage unit.

5. The computer according to claim 3 wherein information stored in said information storage unit comprises at least one of:
a digitized program;
a digitized datum;
a digitized sound; and
a digitized image.

6. The computer according to claim 3 wherein said information storage unit and said information read/write unit comprise, respectively, at least one of:
a hard disk and a hard disk driver;
a floppy disk and a floppy disk driver; and
a magnetic tape and a magnetic tape driver.

7. The computer according to claim 3 wherein said access control system further comprises:
an input receiving unit for receiving a log-in input; and
a logic unit for determining validity of said log-in input, said logic unit providing access to said computer when said log-in input is valid but sending said protection command signal to said guard system when said log-in input is invalid.

8. The computer according to claim 3 wherein said guard system further comprises:
A a signal receiving unit for receiving a command signal from said access control system wherein said command signal comprises said protection command signal; and
an eraser unit for degrading at least a portion of information stored in said information storage unit.

9. The computer according to claim 8 wherein said eraser unit is disposed adjacent said information storage unit and comprises at least one chamber having therein at least one chemical substance capable of altering magnetic property of said information storage unit, said eraser unit configured to deliver said chemical substance from said chamber to said information storage unit responsive to said protection command signal.

10. The computer according to claim 8 wherein said eraser unit is disposed adjacent said information storage unit and comprises at least one chamber having therein at least one chemical substance capable of forming a substantially non-peelable bonding with said information storage unit, said eraser unit configured to deliver said chemical substance from said chamber to said information storage unit responsive to said protection command signal.

11. The computer according to claim 8 wherein said eraser unit is disposed adjacent said information storage unit and comprises at least one mechanical member capable of mechanically deforming said information storage unit upon contact therewith.

12. The computer according to claim 8 wherein said eraser unit is disposed adjacent said information storage unit and capable of generating magnetic field around at least a portion of said information storage unit responsive to said protection command signal.

13. The computer according to claim 8 wherein said guard system further comprises a motion device capable of moving at least one of said eraser unit and said information storage unit with respect to the other of said erasure unit and said information storage unit.

14. The computer according to claim 15 wherein said eraser unit further comprises a motion device capable of moving said eraser unit while said eraser unit generates magnetic field therearound.

15. A method of protecting information processed by a computer from being accessed by an unauthorized user comprising the steps of:
detecting unauthorized attempt to access said information; and
degrading at least a portion of said information upon detecting said unauthorized attempt.

16. The method according to claim 15 wherein the detecting step comprises the steps of:
receiving a log-in input; and
determining validity of said log-in input.

17. The method according to claim 15 wherein the detecting step comprises the steps of:
sensing a disassembly capable of exposing an interior of said computer; and
determining validity of said disassembly.

18. The method according to claim 15 wherein said degrading step comprises the steps of:
contacting at least a portion of said computer with at least one chemical substance, said portion storing said information; and
altering chemical property of said portion of said computer.

19. The method according to claim 15 wherein said degrading step comprises the steps of:
contacting at least a portion of said computer with at least one chemical substance, said portion storing said information; and
altering mechanical property of said portion of said computer.

20. The method according to claim 15 wherein said degrading step comprises the steps of:
contacting at least a portion of said computer with at least one chemical substance, said portion storing said information; and
altering magnetic property of said portion of said computer.
